(19) United States
(12) Patent Application Publication
(10) Pub. No.: US 2023/0184386 A1
(43) Pub. Date: Jun. 15, 2023

(54) METHOD FOR EXTRACTING A LIQUID PHASE OF A CRYOGEN FROM A STORAGE DEWAR

(71) Applicant: Linde GmbH, Pullach (DE)

(72) Inventors: Niels LOSE, Starnberg (DE); Calle Steenberg LOSE, Horsens (DK)

(21) Appl. No.: 17/998,598

(22) PCT Filed: Apr. 26, 2021
(86) PCT No.: PCT/EP2021/025156

§ 371 Date: Nov. 11, 2022

(30) Foreign Application Priority Data
May 18, 2020 (EP) 20020232.3

(51) Int. Cl. F17C 9/00; F17C 3/08

(52) U.S. Cl. CPC F17C 9/00; F17C 3/08; F17C 2223/0161; F17C 2205/0358; F17C 2221/017; F17C 2201/0109; F17C 2201/032; F17C 2201/056; F17C 2203/0391; F17C 2203/0629; F17C 2205/0161; F17C 2205/0323; F17C 2205/0338; F17C 2223/033; F17C 2223/047; F17C 2227/0306; F17C 2227/0339; F17C 2227/0374; F17C 2227/0397; F17C 2270/0509; F17C 2270/0536

(57) ABSTRACT

A method for extracting a liquid phase of a cryogen comprising the liquid phase and a vapour phase from an interior volume of a storage dewar through an extraction means, utilizing a push gas introduced into the vapour phase of the cryogen through an outlet of a supply line provided between a push gas supply and the interior volume of the storage dewar, the supply line partially extending through the liquid phase within the interior volume.

### FIELD OF THE INVENTION

The present invention relates to a method for extracting a liquid phase of a cryogen from an interior volume of a storage dewar.

Cryogenic coolants are used for numerous applications, for example those, in which superconductive magnets are used. Typical examples herefore are Magnetic Resonance Imaging (MRI) and Nuclear Magnetic Resonance (NMR) systems employing such magnets. In order to ensure superconductivity of such magnets, these must be provided at low, i.e. cryogenic temperatures. A typical coolant used in this connection is liquid helium coolant. Usually, the magnet must be filled with such liquid helium, before its superconducting coils can be energised. It is estimated that helium used for such superconducting applications consumes around 20 to 30 percent of total global helium production.

Helium is extracted and liquefied at only a few locations worldwide. After liquefaction, the liquid helium is transported in ISO containers to so-called helium transfills, which are typically owned and operated by gas companies. At these helium transfills, liquid helium is decanted from the ISO containers into smaller mobile cryostats, usually referred to as storage dewars, which typically have a gross volume of 100 to 500 litres. In such dewars, the liquid helium is transported to magnets used in MRI applications. After emptying the content of such dewars into the magnets, in a so called an MRI fill, the dewars should ideally contain a certain residual mass of cold gas, which should not be transferred into the MRI, as gaseous helium may cause the MRI to quench, leading to a loss of superconductivity. In case of such a quench, a replenishment of liquid helium, repair and downtime of the MRI are typical consequences, which should be avoided.

Empty dewars, which are typically returned to a transfill station, are sorted into “cold” dewars, with a temperature of less than 10 k within the interior volume, “warm” dewars, with temperatures of 10 to 50 k and “hot” dewars with temperatures higher than 50 k. The temperature in the dewar after emptying the liquid content can be determined by the residual gas content Cold dewars can usually be refilled without further preparation, i.e. pre-cooling steps, whereas warm and hot dewars must be pre-cooled prior to re-filling. Such a pre-cooling of dewars is normally achieved by filling liquid helium into them, until they have collected around 30 to 50 percent of their gross capacity, then allowing them to settle in the recovery system of the transfill for typically 10 to 15 hours. It is desirable to minimise the consumption of liquid helium and time for pre-cooling of dewars.

A storage dewar containing liquid helium will contain, in addition to the liquid helium phase, a vapour phase above the liquid phase. The transfer (emptying) of liquid helium, i.e. the liquid phase, from a storage dewar is achieved by extraction means comprising a flexible vacuum insulated hose, a so-called syphon. In order to allow liquid helium to be transferred, the dewars must be pressurised to a pressure typically ranging from 250 to 350 hPag (3.5 to 5 psig). In order to achieve this, the interior volume of the dewar containing the liquid helium must be pressurised. The most common method of pressurising the interior volume of a dewar is the introduction of gaseous helium from an external source via a gas inlet provided in the upper part of the storage dewar. Via this inlet, the gaseous helium from the external source is directly introduced into the vapour phase. This external gas is referred to as “push gas”.

Introduction of push gas into the vapour phase of the cryogen leads to a high heat input into the dewar, as the heat transfer from the warm push gas (which typically has ambient temperature) in the upper region of the dewar into the liquid phase is poor. As a result, the dewar accumulates excessive heat during the transfer of the liquid phase through the syphon.

A high heat input is undesirable for the liquid phase in the dewar, as well as, for example, in connection with the magnets of an MRI. Moreover, a high heat input will leave the emptied dewar in a “warm” or “hot” condition with zero residual liquid or cold gas. As mentioned above, a warm or hot dewar is undesirable, as it must subsequently be pre-cooled when it is re-filled.

Warm “or” hot dewars, which have been emptied utilizing push gas, typically do not contain any, or very little, residual product when they are returned to the helium transfills, as the residual product is vented, and thus lost, through a transportation safety valve, which must be kept opened during transportation for safety reasons.

Also, dewar pressurisation by means of push gas requires a large amount of external gas, so that gas cylinders with a typical volume of 40 to 50 litres and a weight of 50 to 60 kilograms are used. The gas cylinders must be transported together with the dewars and must be located near the MRI. When the dewar used in an MRI fill runs out of liquid helium, the technician must immediately and manually stop the flow of push gas from the cylinder into the dewar. If this is not performed immediately, there is a risk of “warm” or “hot” gaseous helium from the dewar flowing into the cryostat or magnet of the MRI. This can lead to quench effects within the MRI.

As an alternative to push gas extraction from a storage dewar as outlined above, it is known to pressurise the dewar by means of an electrical pressurisation of the interior volume. This is achieved by means of a so-called electrical pressure builder, built into the dewar. Such dewars are more costly in their purchase and their maintenance. In addition, most dewars equipped with electrical pressure builder have fixed pressure set point(s) which limit the operator in adjusting and optimizing the dewar pressure and the flowrate to the MRI magnet during a fill.

The invention seeks to optimise handling, especially pressurization of a storage dewar utilizing a push gas.

This is achieved by a method according to a claim 1 and a storage dewar according to claim 3.

The invention provides a method for extracting a liquid phase of a cryogen comprising the liquid phase and a vapour phase from an interior volume of a storage dewar through an extraction means, for example a syphon, utilizing a push gas introduced into the vapour phase of the cryogen through an outlet of a supply line provided between a push gas supply and the interior volume of the storage dewar, the supply line partially extending through the liquid phase within the interior volume.

By means of the push gas within the supply line being led through the liquid phase, before it is introduced into the vapour phase, a highly effective heat exchange between the push gas and the liquid phase is achieved, so that cooled push gas, with a temperature essentially just above that of the liquid phase, is introduced into the vapor phase in a headspace of the storage dewar. In addition, the portion of the liquid helium which evaporates due to the heat transferred from the push gas into the liquid phase through the heat exchanger will enter the head space at a temperature equal to the temperature of the liquid helium. Hereby, the risk of introducing push gas bubbles into the liquid phase of the cryogen, which can lead to unwanted quenching effects in an MRI, to which the liquid phase of the cryogen is supplied, is minimized compared to injecting the push gas directly into the liquid phase.

Therefore, the push gas is led through a heat exchanger provided in a section of the supply line within the liquid phase. For example, such a heat exchanger can be provided at or in the vicinity of a flow inverter section of the supply line within the storage dewar, at which the supply line reverses its direction of extension, so that an initial downward flow of the push gas is reversed to provide an upward flow of push gas through the supply line, the push gas being ejected from the supply line within the vapour phase of the cryogen, which is present above the liquid phase, as outlined above.

Advantageously, the dewar pressure, and herewith the flowrate of liquid helium to the MRI magnet can be controlled by a stepless pressure regulator

Advantageously, the push gas is provided as a helium gas. Helium gas is typically stored in high pressure storage cylinders, essentially at ambient temperature. By means of the heat exchange as described above between the push gas and the liquid phase of the cryogen, the temperature of the push gas is effectively reduced, as explained above. Typically, the temperature of the cryogen within the storage dewar is around 4.2 K, so that the push gas will be cooled down from ambient temperature, around 300K, to around 4.2 K.

The invention also provides a storage dewar defining an interior volume, comprising a lower section and an upper section for storage of a cryogenic, comprising an extraction means for extracting the cryogenic from the interior volume, and a supply line for introducing a push gas into the interior volume, the supply line extending, in a first section, from the upper section of the interior volume to the lower section, and then, in a second section, back from the lower section to the upper section of the interior volume, an outlet, through which push gas exits the supply line being provided at or in the vicinity of a terminal end of the supply line in the upper section.

With this design of the storage dewar, the supply line can enter the dewar at its upper side into the first section, which will typically at least in part coincide with the gas space, in which the vapour phase of the cryogen is present, extend down to the second section, which will at least in part coincide with the liquid phase of the cryogen, and then back upwardly into the gas space, where the cooled push gas will be introduced into the vapor phase of the cryogen.

Expediently, the supply line comprises an extension reversal section in the lower part of the interior volume.

Therefore, the supply line is provided with a heat exchanger, for example at or in the vicinity of the extension reversal section. By means of a heat exchanger immersed in the liquid phase of the cryogen, a highly effective cooling of the push gas can be achieved. The heat exchanger can, for example, be provided as a finned heat exchanger.

According to a preferred embodiment, the first of the supply line within the interior volume is provided as a coaxial vacuum jacketed pipe, and/or a second section of the supply line within the interior volume is provided as a single walled pipe. By means of this design it can be ensured that a heat exchange between the push gas and the liquid phase is minimized in the portion of the supply line upstream of the heat exchanger, thus optimizing heat exchange within the heat exchanger, and further supporting this heat exchange in the portion of the supply line downstream of the heat exchanger.

Advantageously, the heat exchanger is arranged between the first section and the second section of the supply line.

According to a preferred embodiment, the second section of the supply line is provided concentrically around the first section.

Advantageously, the heat exchanger is provided concentrically around the first section and concentrically within the second section of the supply line. This design provides a compact robust arrangement of the supply line, and advantageously also the heat exchanger, within the dewar.

An advantageous embodiment of the invention will now be described with reference to the accompanying figures. Herein

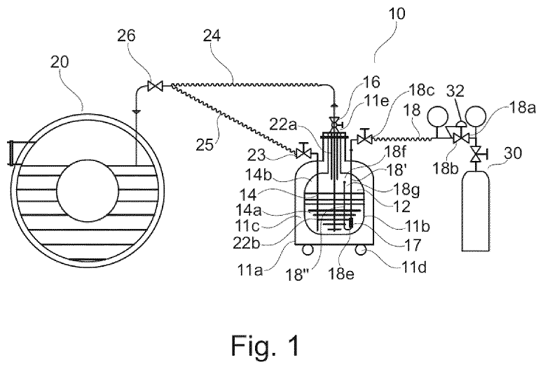

FIG. 1 shows a schematic side view of a system for performing a preferred embodiment of the method according to the invention including a preferred embodiment of a storage dewar used for filling a magnet of an MRI,

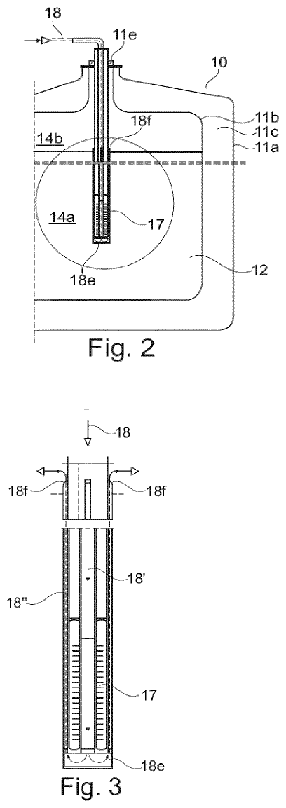

FIG. 2 shows a further preferred embodiment of a storage dewar, and

FIG. 2 a more detailed side sectional view of a section of a pipe or supply line by means of which push gas is introduced into the storage dewar of FIG. 2.

In FIG. 1, a cryogenic storage dewar for storing and transporting a cryogen 14 is generally designated 10. The cryogen comprises a liquid phase 14a and a vapour phase 14b above the liquid phase 14a. The dewar 10 serves to refill an MRI magnet 20 with liquid phase cryogen. Also, a cylinder 30 serving as a push gas supply is shown, which constitutes an external source for push gas. Cylinder 30 has a volume of preferably 10 to 20 litres. Be it noted that this volume is substantially smaller than that of cylinders used in conventional systems, which typically use cylinders with volumes of around 40 to 50 litres. This reduction in size, which also reduces transport costs, is possible due to the fact that a substantially smaller amount of push gas is required according to the invention, as will be further explained below. The push gas is pressurised at ambient or room temperature within the cylinder 30. Dewar 10 and cylinder 30 are made of non magnetic materials.

Dewar 10 is an insulating storage vessel and comprises an outer shell 11a and an inner shell 11b, the space 11c between inner and outer shell being partially evacuated. At its lower or bottom side, the dewar 10 can be provided with transportation means, such as wheels 11d. The space surrounded by inner shell 11b is defined as interior space 12 of the dewar 10.

At its upper side, the dewar 10 is provided with a sealable opening 11e, through which the dewar can be filled with cryogen. The sealable opening is provided with a top valve 16, through which liquid cryogen can be extracted from the dewar 10 and transported to the MRI magnet 20, as will be explained in the following.

Be it assumed in the following that the cryogen 14 included in the interior volume 12 of the dewar 10 is helium. This helium comprises liquid phase 14a, and above this liquid phase vapour phase 14b, as mentioned above. Under storage conditions, the liquid phase 14a and the vapour phase are in thermodynamic equilibrium. A typical temperature within the interior volume of the dewar 10 is 4.2 K. The push gas contained in cylinder 30 is also helium, which has ambient temperature, i.e. around 300 K.

The push gas from cylinder 30 can be introduced into the dewar via a supply line 18. As indicated in FIG. 1, the supply line 18 is provided with valves 18a, 18b, 18c, and extends from the cylinder 30 into the interior space 12 of dewar 10. The pressure of the push gas entering the dewar can be regulated by a conventional 2-stage high accuracy gas pressure regulator 32. On the side of the dewar 10, supply line 18 extends from valve 18c through the upper side of dewar 10, passing through outer shell 11a, space 11c, inner shell 11b into the upper section of interior volume 12, the so called head space or gas space, from where it extends vertically downwards into the lower section of interior volume 12, reverses its direction of extension in a reversal point 18e, from which it extends upwardly back into the upper section 14b.

In the vicinity of reversal point 18e there is provided a heat exchanger 17, which is advantageously provided as a finned heat exchanger, for heat exchange between the helium acting as push gas passing through supply line 18 and the liquid phase of the cryogen, i.e. liquid helium 14a, within the dewar 10. The supply line upstream of heat exchanger 17 (designated 18′) is provided as a coaxial vacuum jacketed pipe. Downstream from heat exchanger 17, the supply line 18 is provided as a single walled pipe (designated 18″).

The interior space 12 contains helium as a cryogenic, including a liquid phase 14a and a vapour phase 14b above the liquid phase, as already mentioned. Thus, within the interior space 12, the supply line 18 extends through the vapour phase 14b, then through the liquid phase 14a, and terminates in the vapour phase at an opening section 18f.

For transportation of liquid helium from the dewar 10 to the MRI magnet, a syphon 22a,22b is provided between the dewar 10 and the MRI magnet 20. In FIG. 1, two alternative syphon designs are shown: The syphon 22a is provided with top valve 16, mentioned above, as syphon valve. The syphon 22a can be inserted through the sealable opening 11e of the dewar and fixed therein. Syphon 22a is connected to a transportation line 24 for transporting liquid cryogen from the dewar 10 to the MRI magnet 20.

Alternatively, or additionally, the dewar 10 can be provided with a built-in syphon 22b and a built—in side outlet valve 23. Syphon 22b is connected to a transportation line 25 for transporting liquid cryogen from the dewar 10 to the MRI magnet 20. A further flow control valve 26 is provided in transfer line 24 and/or transfer line 25. Both syphon alternatives 22a,22b are shown in FIG. 1, although typically only one of the alternatives provided.

In order to transport liquid helium 14a from the interior space 12 of dewar 10 to the MRI magnet, pressurized gaseous helium from cylinder 30 is transported into the vapour phase within the interior volume through supply line 18 by means of the opening of valves 18a, 18b and 18c.

During its passage through the supply line 18, especially heat exchanger 17, within the dewar, this gaseous helium is cooled down to essentially the temperature of the cryogen within dewar 10, at the same time retaining its gaseous state. Advantageously, heat exchanger 17 is dimensioned such that a large part of the heat energy, preferably up to 99%, contained in the ambient temperature helium being uses as push gas, is transferred to the liquid helium in the dewar 10. This will cause part of the liquid helium to evaporate, thus increasing the pressure of the vapour phase in the head space of the dewar 10.

Thus, the pressure within dewar 10 increases not only by means of the push gas being introduced into the vapour phase, but also by means of the evaporated liquid phase. Utilising this effect, by opening valves 16 and/or 23, as well as valve 26, liquid helium will flow through syphon 22a and/or 22b and the transportation line 24 and/or 25 into the MRI magnet 20. As the pressure of the vapour phase in part increases due to evaporation of liquid helium, substantially less push gas is required to generate and maintain sufficient pressure in the vapour phase compared to prior art solutions.

In addition to cooling of the push gas in the heat exchanger 17, a further cooling is achieved in the single walled pipes in the section 18″ of the supply line downstream of the heat exchanger. By means of providing a push gas essentially cooled down to the temperature of the cryogen, the danger of introducing helium gas bubbles into the liquid phase 14a within the dewar 10 can be essentially eliminated, whereby quench effects within the MRI magnet can be avoided.

By providing the supply line 18′ upstream of the heat exchanger 17 as a vacuum jacketed pipe, it is possible to avoid or at least minimise heat transfer from the pipe into the gas phase in the header of the dewar. The heat transfer will increase as the liquid level in the dewar drops and more and more heat transferring area will be exposed to the gas phase. This means that the temperature of the gas phase can not be controlled. The advantage of focusing the heat transfer only to the heat exchanger submerged in the liquid in the lower part of the dewar is to ensure that the gas generated by evaporated liquid is vapor (gas with the same temperature as the liquid).

With the invention, a very low mass flow of push gas, typically smaller than 10 nl/minute (normal litre per minute, the “normal” reference condition being 0° C. and 1013 mbara) can be achieved. This means that the total usage of push gas for filling a MRI magnet will be 3-4 times lower compared to the conventional push gas methodology. Also, the heat exchanger 17 can work very efficiently, as it is submerged in the liquid phase 14a. As mentioned, the cooled push gas will have a temperature very close to that of the liquid phase 14a, and the liquid phase and the vapour phase will stay very close to thermodynamical equilibrium.

In FIGS. 2 and 3, a preferred embodiment of dewar 10 and heat exchanger 17 together with a preferred design of supply line 18 are shown. In this embodiment, a built in syphon 22b, as shown in FIG. 1, is typically utilised.

Supply line 18 from a push gas supply such as cylinder 30 enters dewar 10 via sealable opening 11e, as shown in FIG. 2. In downward direction, it passes through vapour phase 14b of the cryogenic within interior volume 12 into the liquid phase 14a. As especially visible in FIG. 3, this downwardly extending section 18′ of supply line 18 is provided as the centre of a concentric arrangement, section 18′ being concentrically surrounded by a finned heat exchanger 17 in its lower part, which itself is concentrically surrounded by upwardly extending section 18″ of supply line 18. Thus, pressurised push gas entering the dewar form the push gas supply in supply line 18 will flow downwardly through section 18′ in the centre of this concentric arrangement, further downwardly through heat exchanger 17, following which its direction of transportation will be reversed in reversal section 18e, and it will flow upwardly through section 18″, which concentrically surrounds section 18′ and heat exchanger 17, and exit supply line 18 into the vapour phase 14b at outlet 18f.

The concentric arrangement of supply line 18 with heat exchanger 17 provides an extremely compact and robust design.

1. A method for extracting a liquid phase of a cryogen comprising the liquid phase and a vapour phase from an interior volume of a storage dewar through an extraction means, utilizing a push gas introduced into the vapour phase of the cryogen through an outlet of a supply line provided between a push gas supply and the interior volume of the storage dewar, the supply line partially extending through the liquid phase within the interior volume and wherein the push gas is led through a heat exchanger provided in a section of the supply line within the liquid phase.

2. The method according to claim 1, wherein the push gas is a helium gas.

3. A storage dewar defining an interior volume comprising a lower section and an upper section for storage of a cryogenic, comprising an extraction means for extracting the cryogenic from the interior volume, and a supply line for introducing a push gas into the interior volume, the supply line extending, in a first section, from the upper section of the interior volume to the lower section, and then, in a second section, back from the lower section to the upper section, an outlet, through which push gas exits the supply line being provided at or in the vicinity of a terminal end of the supply line in the upper section of interior volume, and wherein the supply line comprises an extension reversal section in the lower part of the interior volume and wherein the supply line is provided with a heat exchanger in the lower part of the interior volume.

4. The storage dewar according to claim 3, wherein the first section of the supply line within the interior volume is provided as a coaxial vacuum jacketed pipe, and/or the second portion of the supply line within the interior volume is provided as a single walled pipe.

5. The storage dewar according to claim 3, wherein the heat exchanger is arranged between the first section and the second section of the supply line.

6. The storage dewar according to claim 3, wherein the second section of the supply line is arranged concentrically around the first section.

7. The storage dewar according to claim 6, wherein the heat exchanger is provided concentrically around the first section and concentrically within the second section of the supply line.
